(19) United States
(12) Patent Application Publication
(10) Pub. No.: US 2008/0262857 A1
(43) Pub. Date: Oct. 23, 2008

(54) Reducing the Cost of Distributed Electricity Generation Through Opportunity Generation

(76) Inventor: Anil L.M. Perera, Victoria (AU)

Correspondence Address: NOVAK DRUCE + QUIGG LLP, 1300 EYE STREET NW, SUITE 1000 WEST TOWER, WASHINGTON, DC, 20005, US

(21) Appl. No.: 11/721,846

(22) PCT Filed: Dec. 8, 2005
(86) PCT No.: PCT/AU05/01863

§ 371 Date: Jun. 15, 2007

(30) Foreign Application Priority Data
Dec. 16, 2004 (AU) 2004907153

(51) Int. Cl. G06Q 50/00

(52) U.S. Cl. 705/1

(57) ABSTRACT

A new disposition of energy use and electricity cogeneration facilities at a customer's premises that enables even a small customer to choose one or more forms of primary energy from among available energy sources, so as to reduce the overall capital and operating costs of meeting own load requirements. Takes into consideration opportunities to save money by way of reducing own load and/or opportunities to earn money by exporting electricity to the mains grid whenever electricity market prices are high, and/or benefiting from payment for network support and ancillary services where such schemes apply. For operations requiring a high level of reliability, opportunity is provided to achieve a desired level of reliability for operations at the premises without recourse to extra cost of duplicate electricity supply connecting lines or expensive stand-by power generation facilities.

### FIELD OF THE INVENTION

The present invention relates to a new disposition of energy conversion and electricity generation facilities at a customer's premises, that reduces the overall cost of energy use by the customer, improves the customer's reliability of supply and can also contribute to improving the reliability of the power system. The invention extends the scope for distributed generation and co-generation by reducing both the initial capital cost and the significant operating cost premium when undertaking electricity cogeneration at the user premises. The invention allows the end customer to be the ultimate arbitrager able to choose whether to use electricity or another primary fuel to satisfy a significant portion of energy requirements at the premises based on price differentials in die respective energy markets.

### BACKGROUND DESCRIPTION

During the early stages of development of the electricity supply industry (ESI), the reliability of the power supply system was low by today's standards and as a consequence customers who placed a high value on reliability eg hospitals, high rise office buildings, etc, had stand-by electricity generation facilities for their own use when the mains supply was interrupted or was unavailable for any reason. This involved considerable initial investment and the running costs to operate the stand-by generating unit was more compared to the cost of electricity supplied from the power grid (where the applicable tariffs were largely based on supply costs of low marginal cost base-load electricity generating plant, with a small premium to account for the small proportion of energy supplied from higher cost mid-point and peaking generation plant).

The base load electricity generating plant and other large generator units usually had fuel efficiency ratios lying between 25% and 50%. By the introduction of secondary heat recovery circuits e.g. medium pressure steam raising and/or economizers to heat boiler feed water, it was possible to capture the primary circuit exhaust heat thereby increasing the fuel efficiency of the station to around 70%. In the art it is recognized that by using the waste low temperature heat from the condenser or the prime mover exhaust, it is possible to improve the fuel efficiency still further to around 80%. Except in some European applications (e.g. district heating schemes), the base load plant was mostly situated close to the fuel source e.g. coal mines, and there is little opportunity to use the waste low temperature heat. With the introduction of packaged gas turbines and the opening-up of die industry to independent power producers, interest in co-generation was revived. Such co-generation facilities cover shared use of steam from a boiler/steam turbines where part of the steam after the first stage of the steam turbine (which drives the generator) is diverted for use in the custolmer's processes or the exhaust heat from the gas turbine is used to raise steam for a steam turbine, and/or the low temperature heat from the exhaust gas is used to provide hot water for use by the customer. There were cost synergies in having one boiler provide for both requirements, and from combining the fuel purchasing and handling. Yet considering that unit sizes were smaller than base load plant (loss of economy of scale) and the additional cost of fuel transport/handling compared to fuel cost for base load plant (at wholesale prices), the co-generation option was economical only in few cases. Exceptions included places like a petroleum refinery, where the fuel was an internal by-product not easily sold for alternate use and/or where the reliability of electricity supply for plant operation was critical. In more recent years, with improved natural gas availability and the considerable reduction in the cost and the wider size range of gas turbines for electricity generation, there has been a small increase (big increase as a percentage but from a very small base, a rough estimate being less than 100 such cases in Australia) in the use of co-generation mostly in the range 1 to 20 MW.

Energy industry restructuring has led to the establishment of pool markets where electricity and gas are traded on a real-time basis depending on the balance between supply and demand. Most of these markets have clearing prices set close to real-time. The resulting prices, especially for electricity has been very volatile. Ready availability of low cost natural gas have led to greater use of gas turbines for electricity generation, with consequent improvements in gas turbine design and reductions in their initial cost. In the United Kingdom, one of the pioneers in electricity industry restructuring and also having a well-developed natural gas market, we have seen the emergence of dedicated tolling stations (that will convert gas into electricity for a fee)—which provided the opportunity to arbitrage between prices in the electricity and gas commodity markets.

Because the above-mentioned developments have occurred only on a limited scale, they have not had much impact on the outcomes of the electricity market where prices still continue to be volatile. Up to now, there has been no opportunity for small customers to participate in these developments and to a large extent small customers have remained hostage to the market power of large portfolio generators and the monopoly network operators. That is needed is a low cost option that embodies the desirable aspects of stand-by generation, of co-generation and of tolling stations, and to make such options economically viable even to small customers such as residential customers. To distinguish such an arrangement from other known generation arrangements, the new arrangement described in the invention is called ‘Opportunity Generation’ and is proposed as being well suited for mass-market application. The application of the invention will then give the customers OPPORTUNITY POWER™ (registered Trade Mark in Australia) to dampen excessive price excursions in pool type energy markets—so vital to achieving an efficient energy market. Australian Patent No. 748800 (Perera) ‘Method to enable customers to respond to prices in a pool type energy market’, which is incorporated in its entirety by reference as if it was completely set out herein, disclose a method of trading units of energy and a system that monitors and controls the use of energy and energy substituting devices at the customer premises, to achieve the preferred trading outcome. One embodiment provided for the use of energy substituting devices for the supply of energy from a source other than the mains supply, either feeding the premises load after isolating it from the mains electricity supply or with both the load and the source of energy run parallel to the mains supply if frequency matching was not a problem.

The present invention relates to a novel method, one embodiment of which can be used in such an energy supplementing/substituting manner and has a substantially lower overall cost than traditional stand-by electricity generation, co-generation or energy storage facilities, and provides an economic opportunity for choosing the energy source based on the market prices for electricity, natural gas or other fuels.

Surveys to establish what value customers attribute to high reliability of supply (less number of outages and/or lower aggregate outage duration for a given period) have consistently demonstrated that small (and many rural) customers place substantially lower value on a high level of supply reliability and that commercial/some large customers place a substantially greater value on high supply reliability. Real ‘customer choice’ requires that the customer have the ‘opporitnity’ to decide whether or not to use electricity depending on the underlying price at the moment of use and not be forced to pay too high a price for a high level of reliability—often a significantly higher price than the value imputed by the customer to such a high standard of service. The method described in Australian Patent No 748800 enabled a customer to forego the use of a predetermined quantity of electricity and sell that quantity back to the contracted merchant at the prevailing pool price, but the benefit is small if the incidence of a high pool price event happens during a period when the customer contracted quantum of electricity usage for that interval was small. Having the facility to generate own electricity means that the opportunity to profit from a high pool price event is not restricted to the contracted usage profile. It is one intention of this invention to provide even small customers an option that enhances the benefits from the application of real-time tariffs and support systems described in Australian Patent No. 748800

One aspect of the restructuring of the electricity supply industry is to have open markets for trading electricity and involves the interconnection of previously discrete electricity supply areas serviced by their area specific vertically integrated monopoly electricity supplier. These discrete supply areas were characterized by having large generating stations, usually located close to primary sources of energy, with means of transporting the electricity generated to end use customers by a system of transmission and distribution lines. These networks were not designed to transport large quantities of energy right across the supply area, but rather to transport electrical energy from generating source to users up to the end of the transmission/distribution lines. In most cases the supply facilities to the borders of the supply areas were designed to only supply the generally small local load in that border area. Further, the network system was designed to complement the full set of generating stations within the franchise area and as such there was a recognition that versatility in generation facilities supplemented network deficiencies or in other words, the network was designed, built and maintained on the basis of serving the given customer mix at the least cost, in the context of the total power system in the franchise supply area.

With the introduction of competition in generation within a broader region which is an aggregate of such previous monopoly supply areas, each generator company is now trying to get the best financial outcome by supplying to, withholding (e.g. scheduled maintenance) or diverting supplies (where bilateral contracts are allowed) from, the new pool type clearing market. There is now more strain on the capacities of networks than there was previously—often using up the network redundancy that supported supply reliability. Also because of pooling of spare generating capacity, large swings in power flow are now more likely, placing more stress on the trunk transmission lines within the power system. Since electricity power flows in meshed systems (allows number of parallel flow paths) tend to take the path of least resistance and line/transformer resistance (including capacitive and inductive impedance) varies with ambient temperature and flow conditions, large interconnected power systems are more prone to catastrophic failure as evidenced by the recent spate of major blackouts in USA/Canada (August 2003), Auckland 1998 (39 days), Italy September 2003, Sweden-Denmark 2003, etc. affecting millions of customers and some outages taking days to restore supply to all affected customers.

There are also situations when load growth has outpaced network augmentation that should have happened, resulting in non-firm supply (lacking redundancy, failure of a line component will result in loss of supply) during some periods of extremely high load or following the failure of a transmission line component or a generator trip. Such instances of network constraint or non-firm supply, has implications on the ability to provide a reliable supply to customers and may also have an impact on the pool price. In some jurisdictions, catastrophic power system failure is averted by shedding load to restore required level of redundancy, but such arrangements are an acknowledgement by that jurisdiction of a failure of market mechanisms (and/or regulatory process to oversight appropriate network augmentation) to ensure supply and demand can be balanced at all times. Australian Patent No. 748800 described a method which enabled the network operator to add a price premium over and above the pool price incentive for demand side response thereby providing extra incentive for customers in such affected areas to participate in load management and thereby restore the desired level of network redundancy. The present invention by reducing overall cost of in-house electricity generation facilities, enhances the capacity of even small customers to profitably participate in such demand side response.

### Capital and Fuel Cost Estimates

Fuel efficiency of the generator unit is only one of the factors that determine delivered price of electricity to the end customer. Consideration needs to be given to the cost of the fuel delivered to the generator unit. In the case of coal power stations situated close to the coal mines (e.g. brown coal in Victoria comes from open pit mines within conveyor carrying distance from the power station), the fuel cost to produce one unit of electricity can be substantially lower than for any other fuel source. An indication of short run and long run marginal costs of generation in Australia is provided in Table 1 given below, which is extracted from a study by ACIL Tasman “SRMC and LRMC of Generators in the NEM—A Report for the IRPC and NEMMCO” (April 2003) and is hereby incorporated by reference.

TABLE 1
Short run and long run marginal costs of electricity generation in Australia

| | Black Coal | Brown Coal | Combined | Open Cycle | Open Cycle |
|---|---|---|---|---|---|
| | (Qld) | (Vic) | Cycle Gas (Vic) | Gas (Vic) | Gas (Vic) |
| Installed Capacity | 450 | 500 | 385 | 100 | 100 |
| (MW) | | | | | |
| Installed Cost ($M) | 630 | 900 | 385 | 50 | 50 |
| Capacity Factor | 85% | 90% | 70% | 5% | 10% |
| Cost of Fuel ($/GJ) | 0.75 | 0.38 | 3.15 | 5.00 | 5.00 |
| Fuel Efficiency | 40% | 28% | 49% | 29% | 29% |
| Fuel Cost ($/MWh) | 6.78 | 4.87 | 23.14 | 62.06 | 62.06 |
| Capital Cost ($/MWh) | 15.77 | 19.15 | 12.58 | 86.35 | 43.17 |
| Total Cost ($/MWh) | 31.42 | 33.60 | 43.77 | 183.47 | 126.77 |

Note: Prices are in 2001/02 terms

Given the typical capacity factors for the different types of generating plant, the fuel cost (much of the marginal cost of generation) is the lowest for brown coal power stations, with the fuel cost for die higher efficiency gas turbine being around four times dearer Although the installed cost (capital cost component) of the gas turbine generator is substantially lower than for the coal power stations, the total cost ($/MWh) still comes out to be about one third more than for both types of coal fired power stations. The explanation being that the gas turbine is usually used as a midpoint/peaking plant due to it's easier start/shutdown capabilities and also needs more maintenance—so runs at a relatively lower capacity factor. Growing customer affluence and higher affordability of appliances such as air conditioners, have combined to increase the peakness in the annual system load as indicated in the load duration curve for Victoria in 2002 shown in Graph 1 below.

The maximum regional demand in Victoria during 2002 was 7,581 MWs and there were just 82 half hours where the demand exceeded 7,000 MWs. This translates to having 581 MWs of generating capacity needed to operate for less than 42 hours in the year—a heavy financial burden indeed.

There are growing demands that the current pool price cap in the Australian National Electricity Market (currently $ 10,000 per MWh) be substantially increased to ensure there is sufficient financial incentive for new investment in peaking plant that get to run only a few hours in the year.

### DESCRIPTION OF RELATED ART

With gradual increases in the level of reliability of electricity supplied through the mains, stand-by generating facilities gradually came to be regarded as an unnecessary expense. Now it is possible to have more targeted stand-by supply arrangements such as Un-interrupted Power Supply (UPS) for computers and/or battery/capacitor charge back-up either with inverter system to convert to alternating current or by itself as for electronic clocks embedded in electrical appliances. The dilemma with tying to maximise the use of stand-by generators is that while they are able to respond to high pool prices (automatically if using the method described in Australian Patent No 748800), the extra capital cost of the generator set remains a financial burden. Co-generation, although primarily motivated by the benefits from increased fuel efficiency, is also seen as providing extra security of supply, as it is then possible to use the mains supply as a stand-by source of power, when the co-generator is not available for any reason. A characteristic of the pool market is that most of the time electricity prices are low, as they are set by the large-scale base load generators whose marginal cost is low. Very occasionally there are short bursts of very high prices when higher cost generators bidding a very high price also need to be dispatched to meet load requirements. Graph 2 below is a price duration curve and shows the Half Hour Regional Price for electricity in Victoria during 2002. In 2002 there were 28 half hours when the price was above $

1,000 per MWh, 169 half hours when price was above $ 100 per MWh. For 12.8% of the time prices were above $40 per MWh and for 32.9% of the time prices were above $30 per MWh. Given that using coal for small power supply systems is not practical and the price of gas which is supplied via the distribution system to retail customers can be substantially higher than the price of gas supplied to power stations via trunk mains, instances of co-generation has been few and far between. Where co-generation has been successful is when the transmission or the distribution network offers a network support payment (based on capital cost savings in deferred investment to overcome a network constraint) and/or the fuel used is a by-product of the main activity or otherwise have little value in an alternate use, eg. bagasse from sugarcane.

An example of prior art of a co-generation system can be seen in U.S. Pat. No. 6,525,431 which concerns a co-generation system for a domestic or commercial building, being a system which includes a water storage tank, whereby the system provides for secondary heat recovery from the Stirling Cycle engine, and provides means for reduction in die vibration and noise of the engine used. A further advantage cited is that the storage tank for the coolant water and the coolant water itself are used for the secondary heat exchange and as the means to reduce the noise and vibration of the engine.

Considerable effort is being given to other new co-generation technologies like fuel cells, which enable electricity, water and heat to be co-generated without actual combustion of the input hydrogen fuel. The preliminary stage usually involves natural gas (containing mostly methane) being converted to hydrogen with emission of carbon dioxide—although more efficiently than when combusted by other means. Proponents claim energy conversion efficiencies between 50 and 70 percent for the combined process.

A report by the US Congressional Budget Office titled Prospects for Distributed Electricity Generation (September 2003) provided a good comparative cost table of Levelized Cost of Selected Tecliologies Suitable for Distributed Generation applicable within USA and is available at http://www.cbo.gov/showdoc.cfm?index=4552&sequence=0, which report is hereby incorporated by reference.

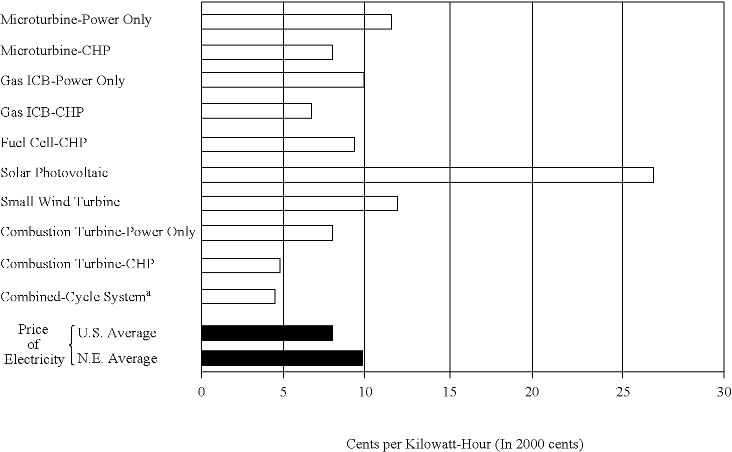

Notes:
CHP = combined heat and power (also known as cogeneration);
ICE = internal combustion engine;
N.E. = New England.
The levelized cost is the average cost of electricity (cents per kilowatt-hour) over the operating life of the generation equipment. Future costs and output flows are based on data in Table 2 and are discounted at 7 percent from their present values. The cost estimates assume that the systems powered by fossil fuels will be operated 90 percent of the time and that the wind and solar photovoltaic systems will run 40 percent and 27 percent of the time, respectively. Levelized cost comparisons donot include the effects of tax credits or other direct subsidies for specific technologies. “Large wing turbine” is not included in the figure (as it is in Table 2) because it is not generally considered to be well-suited to distributed generation applications (typically, it is not located near customers).
^{a}In a combined-cycle system, a combustion turbine is operated in tandem with a steam turbine. The system is included here as a benchmark for the cost of power from new large-scale generators. Transmission and distribution expenses would add an estimated 2.4 cents per kilowatt-hour, on average, to the marginal cost of deliverd power

This Report provided the following insight. “Internal combustion engine generators, including diesel cycle and spark ignition motors, are the most commonly used technology providing backup power for reliability or emergency supply purposes. Units range in size from 5 kilowatts to 7 megawatts. They can burn refined petroleum products (diesel aid gasoline) or natural gas. Models that burn natural gas have very low emissions because of improved design of the combustion process and their use of catalytic converters. The costs per installed kilowatt for units with capacities suitable for distributed generation are among the lowest of all the mature technologies. The problem with the systems described above, is that the increase in the efficiency of fuel use and any relief available by way of ‘carbon credits’ or such schemes, are not sufficient to offset the higher cost of fuel petrol, diesel, LPG or retailed natural gas) at the small retail customer level. The average price of retail natural gas in 2002 for business customers in Victoria was around 5 $/GJ while for residential customers (small users) the price was around 10 $/GJ (Source: Energy for Victoria—Dept of Natural Resources & Environment 2002). As indicated in the above Table 1 input natural gas cost for pealing plant open cycle gas turbine (OCGT) was around 5.00 $/GJ and 3.15 $/GJ for gas used in combined cycle gas turbines as found in mainstream power stations. As combined cycle gas turbines (CCGT) have a fuel efficiency of around 50%, for applications at the retail level to be competitive the efficiency gains from the new co-generation technologies have to offset a fuel price differential of over 100%. A point to note is that the gains have to be from operating costs as the current estimates of the capital cost of these new technology co-generators is not substantially different to CCGT capital costs—which is around 1,000 $/kW. U.S. Pat. No. 3,935,028 ‘Fuel cell set and method’ is an example of early stage fuel cell technology development, which technology even thirty years later has only reached very limited application. As indicated in the report by the US Congressional Budget Office quoted above, the levelized cost of fuel cell output even with combined heat and power use is substantially above the US average price of electricity and even substantially above the levelized cost of using an internal combustion engine running on natural gas and including the use of heat and power. Another disadvantage in some of these schemes is the fact that the possible electricity output is constrained by the amount of useful sustainable heat recovery. On site generation has a financial advantage from the reduction in line losses and would be eligible for additional benefits if a scheme for network support payments was available, but all in all there has not been sufficient incentive for wide scale application of such units.

Heat pumps have been around for many years now. Of late they have been finding wider application, especially in areas where low cost natural gas is not yet available. Their popularity is also influenced by the wider use of air conditioning systems for space cooling—now being demanded by a growing number of affluent consumers, while discerning customers opt for reverse cycle air conditioners that can also be used for space heating. Given that these appliances have a coefficient of performance or COP of around 3 (efficiency of 300%), their marginal operating cost (around 4 cents per kwh of heat output) is about one half the operating cost of natural gas space heating appliances (assuming the gas appliance has a conversion efficiency of around 50%). The electric motor driven heat pumps would also be very competitive compared to the operating cost of new small-scale co-generation units being developed at present. From the customer's perspective, there is the added attraction of being able to have space cooling during the hot summer afternoons. On the other hand, the initial capital cost for complete systems can be much higher than for traditional space/water heaters but is very competitive for applications with small number of vent outlets. U.S. Pat. No. 4,327,561 ‘High coefficient of performance heat pump’ describes a reverse cycle space heating/cooling application using the earth as a heat sink. U.S. Pat. No. 4,392,359 ‘Direct expansion solar collector-heat pump system’ describes a reverse cycle space heating/cooling application where efficiency is improved by using a solar collector.

The present invention is an improvement on both co-generation systems and heat pumps in that it makes it possible to combine the advantageous features of both technologies. It is also able to provide the same functionality as a stand-by generator but at a substantially lower capital and operating cost (in one embodiment of the invention where the driven load is a heat-pump compressor, for majority of the time it is more economical to run the heat pump from the electricity mains than to run the engine). The invention allows the customer to choose the more economic fuel to operate either the electricity drive or the prime mover to satisfy internal load requirements and when desired it can export electricity into the power system—thereby earning a profit and/or attracting network support payments for alleviating electrical network congestion.

U.S. Pat. No. 4,873,840 ‘Energy co-generation system’ describes a co-generation system for producing electricity, heating and cooling. The components include a combustion unit, a boiler connected to the combustion unit, a steam engine and an electrical generator driven by the steam engine A condenser is connected to the steam exhaust port of the steam engine, the condenser supplying heat to a heat system and causing condensation of the steam discharged by the exhaust port. An absorption cooler is connected to the exhaust port of the steam engine, the absorption cooler for cooling fluid of a cooling system. A heat pump or centrifugal cooler can also be driven by the output shaft of the steam engine. The co-generation system can also include a flue gas cooler for further transfer of heat to the heating system.

A more recent innovation is where cogeneration is integrated with a heat pump in that the engine shaft power is able to be applied to drive a electricity generator or to chive the compressor of a heat pump system. U.S. Pat. No. 6,651,443 titled ‘Integrated absorption cogeneration’ is one such example, involving a cogeneration method comprising the steps of:

(a) developing shaft power by operating a fueled turbine emitting heated exhaust gases;
(b) using said shaft power to generate an output selected from the group, consisting of electrical energy or refrigeration;
(c) using said heated exhaust gases to generate steam by applying said gases to a heat exchanger containing a high-temperature-resistant heat transfer liquid;
(d) flowing said heat transfer liquid through a steam generator to generate steam and in heat-transfer relationship with the generator of all absorptive chiller;
(e) delivering steam from said steam generator to a steam turbine to develop output power on an output shaft, and
(f) using the output power on said output shaft of said steam turbine to generate electric energy or refrigeration.

In common with other cogeneration systems, the economic advantage of increased fuel conversion efficiency from the different turbines described above, are often not able to overcome the turbine fuel cost premium at the retail customer level, and works out to be more costly compared to running the heat pump from the mains electricity supply. Further, the systems described that involve turbines run on steam generated from exhaust heat, are only applicable for large installations generally over 1 MW.

Other examples of prior art include the following teachings.

U.S. Pat. No. 4,731,547 (Alenduff, et al) 15 Mar. 1988 titled “Peak power shaving apparatus and method”. The technology described uses a stand-by generator run parallel with the mains supply, which generator would have a substantial initial cost and usually entail a high operating cost premium. According to the disclosed teaching, the stand-by generator output is controlled to maintain power demanded by the operational unit at or below a given set-point, usually associated with aggregated maximum demand over 15 minutes or half hour as stipulated in standard electricity supply contracts prior to introduction of pool type markets for electricity. With the introduction of pool type markets for supply of electricity, new type of supply contracts tend to separate out the competitively priced energy component from the mandated network charges—which component now contains the maximum demand charge (since networks are designed on the basis of serving maximum demand). Given that the network cost component is now generally less than half of the total electricity bill, the significance of the maximum demand charge has been substantially reduced, thereby reducing the benefits of the said teaching. Not only is the present invention able to more economically address the need to contain maximum demand, but it also enables the end customer to arbitrage between variable electricity pool price (pool price can be very high as happened in California and continues to happen though less often in the National Electricity Market in Australia) and engine fuel price in the open market, in the process delivering higher conversion efficiency by eliminating one conversion stage (engine now directly drives the load). U.S. Pat. No. 5,081,368 (West) 14 Jan. 1992 titled “Uninterruptible power supply with a variable speed drive driving an induction motor/generator” describes an uninterruptible power source comprising a separate stand-by power source which acts as an alternate source to the AC power mains, providing the power to drive a motor directly coupled to a generator, from which secondary source power is supplied to the load in question. This is a capital intensive arrangement suited only for situations where supply reliability is paramount.

U.S. Pat. No. 5,015,941 (Dhyanchand) 14 May 1991 titled “Power conversion system with bi-directional power converter having prime mover start capability” describes a specific system that utilizes a brushless generator driven by a prime mover when operating in a generating mode and drives the prime mover when operating in a starting mode. While the present invention uses the common feature of using the induction motor to also generate electricity, there would be embodiments which use the motor in the motor mode to start the prime mover, the choice of the specific arrangement of doing this will depend on site requirements, component availability and cost;

US Patent 2004/0111226 (Brewster, et al.) 10 Jun. 2004 titled “Aggregation of distributed generation resources” describes a method and system to coordinate control of distributed generation facilities by reference to power supply conditions in the regional power distribution system and the power demand data of a customer associated with the distributed power generation facility. Unlike the centralized control approach espoused in the described technology, the present invention relies on autonomous market response by individual customers to conditions that apply in pool type markets, sometimes facilitated by appropriate incentives offered by other market participants such as the relevant retailer, the local network owner or operator, or the regional power system controller as the case may be. Given that the new pool type markets already have a centralized system of generator bids to set price and to dispatch power, a secondary system as described would have only limited freedom to act. Considering also the reluctance of customers to surrender control over their own facilities to an outside authority, the drawback has been that there is insufficient leeway and little incentive to make the system viable. On the other hand the subject of the current patent application is for a new disposition of load, prime mover mid electric motor-generator that lowers overall cost, and a system to operate this based on customer load requirements and opportunity for financial benefit in pool type energy markets along the lines envisaged in Australian Patent 748800 (Perera) filed 21 Aug. 2001.

PCT application WO 01/71881 (Lagod, et al.) of 1 Mar. 2001 describes an energy management system based on on-site stand-by generation facilities. The problem with such systems is die high cost of setting-up separate stand-by facilities and the high operating cost of such systems. The current patent application overcomes these limitations by having the load motor double-up as a generator when driven by the prime mover according to described power transmission system. This reduces installed cost and by driving the load directly from the prime mover as and when required eliminates two energy conversion processes and their associated efficiency losses.

### SUMMARY OF THE INVENTION

The widely used alternating current induction motor in common with other more sophisticated electric motor/generators, has the ability to also run as an electricity generator when driven by a prime mover above its synchronous speed. The invention uses this characteristic to convert almost any electric motor driven application into an economic opportunity drive cum generating system (Opportunity Generation) by adding a substitutable prime mover to the motor driven application thereby enabling the selection of the more economical fuel source to service the given load and when circumstances are appropriate to enable the system is run as an electricity generator with or without the prime mover also servicing the application load at the same time. Whether the load needs to run simultaneously while generating electricity will dependent on the load requirements at that instant, whether intermediate storage facilities can allow intermittent running of the load, and whether there are other drives (prime movers and/or motors) installed for reliability reasons. Whether the load can run simultaneously while the prime mover is also generating electricity will depend also on facilities available for speed control of the generator shaft and the availability of power output regulating means eg a converter-inverter system. Since most motor applications are for time variant loads, the motor drive systems are designed to operate in a ‘on’ and ‘off’ cycle usually controlled by minimum and maximum values of a relevant parameter eg. temperature in the case of a cooling room, pressure/liquid level in a liquid pumping application, etc. Recent designs of heating/cooling systems using heat-pumps tend to use converter-inverters to vary the speed of the motor to suit the load requirement, but by introducing intermediate heat/cool storage it is possible to achieve more economic outcomes (eg cycling duty provides the opportunity for electricity generation for own use and/or export of power to the grid) as described in the invention. For small size applications subject to installed cost constraints, a standard induction motor with a natural gas engine is the preferred option. Given the wide availability of natural gas for space and water heating in most parts of the developed world, this is a viable option for millions of potential customers. In areas not serviced by reticulated natural gas but have facilities for storage/use of Liquefied Petroleum Gas (LPG works out to be cheaper than diesel oil), a LPG engine (or an engine modified to run on LPG) is the preferred option. Due to greater availability and familiarity with diesel engines, such units are also eminently suited especially if there is access to a subsidy to offset the higher cost of diesel and/or a source of supplementary income from such electricity generation and/or adequate savings from co-generation of heat amid electricity and/or is the least cost option to ensure the desired level of reliability of the load application For larger applications micro-turbines and gas turbines may also be used.

The special drive arrangement for the motor that can run as a generator, the prime mover and the driven load and their operation/outputs are all controlled by a computer that can continuously receive information on rotation speeds of the driven load, the motor-generator and the prime mover, information on electricity prices and price for fuel used by the prime mover including forecasts of short term price trends, information regarding on-going load requirements of the driven load, of electricity requirements of other connected loads at the premises, which is able to store information about relevant fixed and variable costs of operating the prime mover, including relevant design/operating data on the driven load, the prime mover and the motor-generator necessary to control their output based on rotation speed, and relevant information about electricity and fuel supply contract conditions and conditions governing the use and export of power into the power grid, and selects whether the load is to be driven by the electric motor, or by the prime mover, or by a combination of both, or the prime mover is to drive the motor as a generator either as alternate to or in addition to driving the load, so as to meet the electricity requirements at the premises with or without export of partial output from the prime mover, or so as to export all electricity produced by the combination of prime mover and generator. Additionally there are switching facilities responsive to control signals from the computer to engage or disengage the power transmission member connected to each of the main components, including computer signals to control fuel supply to the prime mover so as to maintain computed drive speed according to desired load output and/or generator output when the generator is connected, with or without the computer using an inverter/converter unit able to directly control motor speed or generator output.

### BRIEF DESCRIPTION OF THE DRAWINGS

Features, objects and advantages of the present invention will be better appreciated by the reference to the attached drawings and tabulations.

FIG. 1 is a schematic representation of one embodiment of the invention in a high reliability environment as found in a water pumping station. Only key features of the drive arrangement are shown to facilitate comprehension.

FIG. 2 is a schematic representation of one embodiment of the invention in a premises heating application using a heat pump. The representation is of a heating only application for ease of understanding, but most such applications would use the heat pump on a reverse cycle for winter space heating and summer space cooling, in addition to providing hot water for use at the premises.

FIG. 3 is a schematic representation of another embodiment of the invention in a premises heating application using a heat pump supplemented by the use of a solar thermal panel.

### DETAILED DESCRIPTION OF THE INVENTION

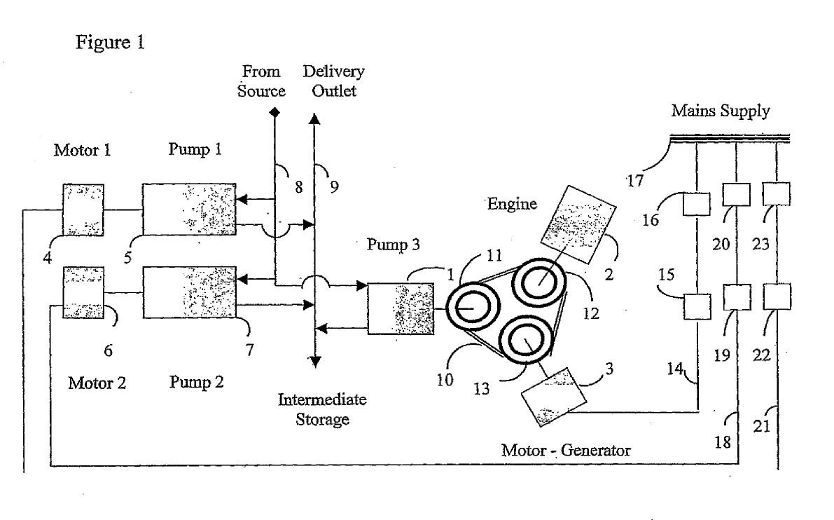

For purposes of clarity, the working of the invention is first described in its application to a simple embodiment of the invention in a high reliability environment such as a water pumping station, as depicted in FIG. 1. The normal design for such a pumping station would have three motor driven pumps, where two pumps would be needed to run in tandem to supply peak load but for most of the time operating one pump is sufficient to meet load requirements (a typical arrangement if there was no intermediate storage). A spare pump-set caters for a situation such as a breakdown of one pump or when one pump is down for routine maintenance. Motors 4,6 drive pumps 5,7 and are supplied electricity by means of the lines 21, 18 from the mains supply 17 via isolators 20,23 and starter units 19, 22

The electricity mains supply to the pump station would normally be sourced from two alternate feeders following different paths preferably originating from two distribution substations. Depending on the location, the spare (alternate) feeder connection cart be a significant cost, often more than the cost of a diesel engine-generator of equivalent rating to one of the pump-sets. It is worth noting that stand-by generation for critical applications is becoming increasingly more relevant again, especially because of the growing size and complexity of large interconnected power systems male them more prone to major blackouts and there is greater potential of customers being disconnected due to power system security criteria being fine tuned to accommodate self dispatch under new competitive market rules. Pumps 5,7 are connected to inlet header 8—which is the source water pipeline, and are also connected to the outlet header 9, which is the delivery outlet. The outlet header 9 may (also) be connected to an intermediate storage tower, which will normally have water level set-points that control the onset and shut-down of the pumps.

The third pump 1 is shown coupled to both an engine 2 and an electric motor 3—which can run as a generator when driven above synchronous speed. The drive coupling system shown is a belt (10) and pulley (11, 12, 13) arrangement designed to suit the drive load requirements, but could be any other suitable arrangement such as a gearbox or a hydraulic drive coupling system. The pulleys 11, 12, 13 also include remotely controllable electric clutch arrangements so that the engine could drive either the pump only, the motor-generator only or both the pump and the motor-generator; as well as allowing the motor to drive the pump only or the engine only or both the pump and the engine. This will enable the motor to drive the engine (may or may not be in decompression mode) up to synchronous speed and then the engine speed can be increased above synchronous speed to generate electricity. In a preferred embodiment the supervisory control facility at the pump station will include a module to automatically perform this part of the synchronizing operation.

The motor-generator 3 is connected to the mains supply 17 by means of the connecting wires 14 including isolator 16 and starter unit 15. Other metering, safety and protection systems required by the supply authorities need to be incorporated but are not shown for easy comprehension. For larger sizes and for more sophisticated applications, item 15 could well be a converter-inverter system which has the advantage that load could be controlled by varying the drive speed as well as enabling more sophisticated power system interaction such as feeding back active and reactive power into the power system. For large applications where reduced voltage starting such as with star delta starters are not adequate to meet distribution system voltage regulation standards, a converter-inverter may well be mandatory. Advances in power electronics and the increasing popularity of such units have helped increase their availability and to reduce their cost. For simple applications needing a low cost outcome, the standard induction motor is well suited but suffers the disadvantage of needing to import reactive power from the mains grid/distribution system. On site capacitors will help reduce this demand on the mains power supply, but there are better options such as the brushless doubly fed induction generator that also has the ability to export reactive power into the grid albeit at a price premium. Such more sophisticated units are eminently suited for larger applications and the extra cost could be partly recovered if there were ancillary service payments available for supplying reactive power to the grid/distribution system.

For clarity computer control system and control accessories are not shown. Many features of the computer control system would be similar to what is described in the Australian Patent No 748800 in respect of monitoring prices, energy supply contract conditions, load requirements at the premises, engaging the generator for export of electricity to the grid, etc. Additionally, the computer control system will be able to monitor outputs of rotational speed sensors on respective drive shafts, access design data on the apparatus being controlled as required to determine rotational speeds appropriate to deliver desired load and/or generated electricity output; be able to compute optimum financial outcomes of using alternate energy sources to drive the load giving consideration to opportunity for financial benefit from exporting electricity; be able to determine optimum intermediate storage parameters e.g. temperature/volume and to determine optimum harnessing of supplementary energy sources like use of solar panels for supplementing heating/cooling duties.

An ‘Opportunity Generating’ system according to the invention—enables arbitrage between electricity market price and gas (or other fuel) market price, as well as enabling export of electricity into the distribution system when it is opportune to do so. Australian Patent No. 748800 provides a method and a system for demand side response to prices in pool type energy markets. Where the application involved is in an area where there are no pool type energy markets, some of the price/demand management incentive features described in the Australian Patent No 748800 need to be negotiated into a suitable supply/buyback contract with the relevant electricity (and gas) retailer(s).

If the ‘Opportunity Generation’ unit is required to run at a time when electricity supply is still available at normal prices, the operating cost of running in the motor mode would be less than the cost to run the engine, except for remote locations where electricity distribution costs are a large component of the electricity retail cost. It is also likely that in such remote locations there is no reticulated natural gas and if what is available is LPG or diesel, the cost differential may still favour operating in the motor mode. During periods when the engine is operating under light load and the electricity export price is high, the spare capacity of the drive engine is able to be utilised to export some electricity to the electricity distribution system by running the motor in the generator mode and the main load devise (eg the pump) together. The engine speed control module will manage the electricity export speed setting and where the load unit speed need to be controlled closely (not much of a problem for water pumps and compressors), preferable to have an externally settable continuously variable gear box (not shown) interposed between the coupling pulley and the load unit.

If the forecast price of exporting power to the distribution system is very attractive, all the devices (pump sets) in the installation may incorporate ‘Opportunity Generating’ systems according to the invention. This way capacity to export electricity can be substantially increased and the benefits are more if the local electricity transmission/distribution network is close to firm capacity and ‘network support’ payments are possible. Arrangements for network support payments need to be negotiated with the transmission and distribution network operators and may need to be on the basis of direct intervention if no automatic system as envisaged in Patent No 748800 is available, In One embodiment of the invention that includes a method of trading units of energy as described in the Patent Application No. 85570/01, trading arrangements of any network support scheme that may apply are incorporated by including as a perineum the corresponding payments specified in the network support scheme (setting the relevant times and quantum of energy use to be reduced and/or the quantum of energy exports), into the contracts agreed with the Merchant and the relevant network service provider(s) as the case may be. The fact that the full capacity of the generator unit can be utilized for export purposes with or without further support by way of reducing normal demand, means that a firm commitment for network support—with the minimum value set at the generator unit rated output, now become feasible.

With Opportunity Generation the initial capital cost is much less than having separate stand-by generation and in most cases is substantially less than the extra cost of a dedicated standby connection line & spare power system capacity. Another advantage is the opportunity to arbitrage between energy markets, especially when the outlook for electricity prices is high. Where energy market arrangements so allow, there is potential to earn substantial amounts of money through electricity export sales (Graph 2 shows 84 hours when pool price >100 $/MWh) and through network support payments.

The arrangements for trading/network support payments can be set-up at die stage of initial application for supply connection, whenever the supply connection has to be augmented due to load growth or when an opportunity arises to renegotiate the supply contract/maximum demand level. Most network regulatory regimes require network owners to canvass demand side response whenever they undertake network augmentation, thereby providing a further opportunity for negotiating network support services if the proposed augmentation assets are upstream of the customer's supply point.

While FIG. 1 and the description so far has only mentioned a single prime mover (engine), it is also possible to have more than one prime mover—eg a windmill or water wheel/mini-hydro turbine drive. When there are more than one prime mover and it is desirable to operate them together, it is necessary to have an arrangement to vary their respective input start speeds—preferably through a continuously variable speed arrangement, so that the drive power utilization can be optimized.

### OTHER EMBODIMENTS OF THE INVENTION

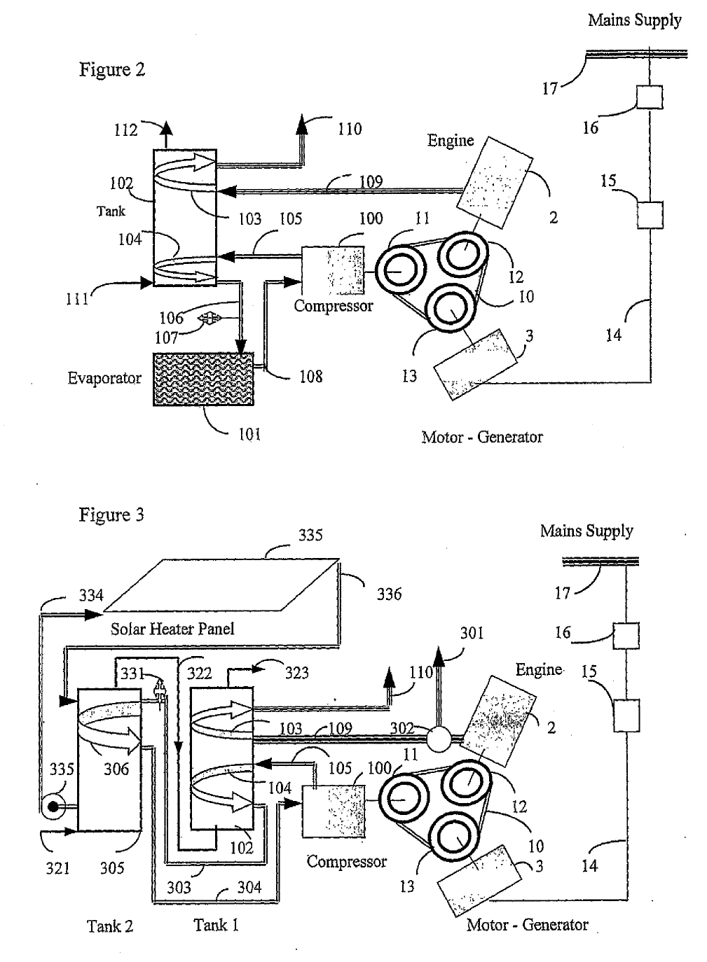

Approximately 75% of domestic energy consumption in temperate climates is for space heating/cooling and hot water. There are an increasing number of manufacturers who supply reverse cycle air conditioners for space heating. One embodiment of the invention in such circumstances is depicted in FIG. 2 and envisages combining water heating and space heating by use of a hydronic system. By combining the two loads in this manner, a larger size Opportunity Generating unit can be used thereby increasing the capacity to sell back electricity when appropriate. To simplify the explanation only the heating circuits are shown, but as a person conversant in the art would appreciate, by adding a cool water tank and change over valves, the depicted system could easily be j converted to provide space cooling as well.

FIG. 2 has a compressor 100 as the load unit, connected to the condenser 104 by means of pipe 105, thereafter the working fluid passes through an expansion valve 107 on the pipe 106 connecting the condenser 107 to the evaporator 101. Evaporator 101 may have an external fan (not shown) to blow ambient air across the evaporator tubes and/or a circulating water system wetting the outside of the tubes. The fluid is returned to the compressor through the connecting tube 108. The condenser 104 is housed inside a storage water tank 102, with the water inlet 111 at the bottom and an outlet 112 at the top. Tank 102 also houses the heat exchanger tube 103 which carry the exhaust gasses from the engine 2 via pipe 109 before being emitted to the atmosphere via silencer 110. Although not shown, another heat exchange circuit could be used to extract useful heat from the engine jacket cooling fluid.

Combining the heat pump with a hydronic heating system has the advantage of increasing the coefficient of performance (COP) due to better heat transfer at the condenser and/or evaporator tubes which are now in contact with water (with COP between 4 and 6 as found in commercially available systems for swimming pool water heating) rather than with air (usual COP around 3). While different types of heat pump could be used, high efficiency units using scroll type compressors are preferred if the cost burden is not too much. A further advantage in such an arrangement is the capacity to have heat storage via an appropriately sized hot water storage tank. This will enable the heat pump to be operated on an intermittent basis, thereby having the capacity to export up to the maximum of the (engine 1) generator rated output of electricity during no load periods. The size of the heat storage tank will determine the leeway available to optimise the sizing of the heat pump, engine and the motor/generator unit consistent with load requirements, also taking into consideration expected fuel prices and expected electricity prices for own use/export. A major drawback of wide spread use of heat pumps is the tendency for their simultaneous operation (eg a ‘cold snap’ or at morning ‘wake-up’ time) creating local load peaks on the distribution/transmission system. Having a hot water storage tank and/or a preheat timer helps to flatten some of the peakness in the local load. Depending on the size of the heat storage facility 102 as shown in FIG. 2, it is possible to even export electricity at such peak periods and to benefit from network support payments if available. Operating the Opportunity Generator with the automatic system described in Patent No 748800 provides the opportunity to benefit from most price excursions in pool type energy markets.

One major drawback in using heat pumps in temperate climates is that when the ambient temperature drops close to or below the freezing point, the efficiency of the heat pump drops significantly. In such circumstances it is preferable to utilize ground water heat or solar heater panels to provide heat input to the evaporator. An embodiment of the invention using a solar heat panel 335 is shown in FIG. 3, the heat from which is used to heat the water in storage tank 305 using pump 335 and connecting pipes 334 and 336. The heat pump evaporator 306 is housed inside the tank 305 connected to the condenser 104 via pipe 303 also containing the expansion valve 331. The makeup water enters the tank 305 at the bottom via pipe 321 and the warm water passes to the bottom of the hot water tank 102 from the top of tank 305 through pipe 322. The working fluid returns to the compressor via pipe 304. Hot water for use at the premises is drawn from pipe 323 at the top of hot water tank 102. To provide for extended operation of the generator, FIG. 3 shows a diversion valve 302 that will vent exhaust gasses to the atmosphere through the silencer 301 if the temperature in the hot water tank 102 reaches the high temperature set point.

As a person conversant in the art would appreciate, the arrangement shown in FIG. 3 can be easily modified for running the heat pump in the reverse cycle mode for summer space cooling by introducing a separate cold water tank to house an alternate evaporator coil and running the solar panel pump in the night time to store cool water in tank 305. Heat exchanger coil 306 will then act as the condenser for the heat pump reverse cycle. As the hot water requirement during summer would be less than during the winter, the exhaust heat from the engine may be enough to maintain the temperature in the hot water tank 102, but when the engine is not running or the hot water temperature drops below the lower set point temperature, the heat pump could be run in the heating cycle to provide supplementary heat to the hot water tank 102. For summer cooling the hydronic system will use the cold water from the cold water tank (not shown) instead of hot water from the hot water tank 102.

Given current estimates for meeting the urgent needs to augment the electricity generation, transmission and distribution systems the world over (involving many billions of dollars), the significantly lower capital cost of wide spread application of the invention will have immense value in establishing more viable and robust energy markets that are self regulating rather than having to depend on external intervention/regulation—which arrangement has up to now been ineffective. Lowest cost for base load generation facilities is through the use of gas turbines costing around $ 750,000 per MW, to which must be added almost an equal amount for the cost of network augmentation. A natural gas/diesel engine generator set would be less than $500 per 1 kW, which is equivalent to $500,000 per MW. Other pieces of equipment like converter-inverter, drive systems & control systems are estimated to add around $5,000 for a small sized installation. Heat pump or oilier load arrangements can be cost justified on their own performance improvement capacity. Graph 3 below shows the daily average of Victorian regional electricity pool prices and Victorian gas pool prices for 2002. High electricity prices have a tendency to influence gas pool price due to the significant draw of natural gas for electricity generation. Yet it is evident that there are a large number of days when the daily average electricity price is significantly above it's annual daily average price but the gas pool price has not changed very much. When we drill down to the level of half hour electricity pool prices, there are much more instances of electricity price excursions that do not affect gas pool price. The invention, preferably working in conjunction with Australian

Patent No 748800, is ideally suited to beneficially respond to such instances of significant energy market price differentials even when operating at the small customer level. Low cost primary fuel options such as biogas, bio-diesel, ethanol, etc have not found commercial application due to problems in achieving sustainable economic production volumes. The present invention provides the opportunity for such fuels to be economic at even small production volumes, specially hi remote areas where natural gas is not available and transport costs of LPG or diesel could be extremely high.

Although the present invention has been described with reference to preferred and other embodiments, numerous other arrangements may be devised by one skilled in the art, without departing from the spirit or scope of the invention. Modifications and substitutions to the present invention made in view of these teachings is considered to be within the scope of the present invention, which is not to be limited except by the claims which follow.

1. A system for managing the supply of energy to a customer that receives power from an electric power grid, comprising:
at least one power transmission arrangement for selectively coupling any two or engaging all three of the following main components: a driven load, an electric motor which can also operate as a generator (motor-generator), and a prime mover;
a computer-driven controller that can continuously receive information on drive shaft rotation speeds of the load, the motor-generator, and the prime mover; information on electricity prices and price for fuel used by the prime mover including forecasts of short term price trends; and information regarding on-going load requirements of the driven load and of electricity requirements of other connected loads at the premises; which controller is able to store information about 1) relevant fixed and variable costs of operating the prime mover including relevant design/operating data on the driven load, the prime mover, and the motor-generator necessary to control their output based on rotation speed, and 2) relevant information about electricity and fuel supply contract conditions and conditions governing use and export of power into the power grid; and which controller selects whether the load is to be driven by the electric motor, by the prime mover, or by a combination of both, or whether the prime mover is to drive the motor as a generator, either as an alternate to or in addition to driving the load, so as to meet the electricity requirements at the premises with or without export of partial output from the prime mover or so as to export all electricity produced by the combination of prime mover and generator; and
a switching arrangement responsive to control signals from the computer to engage or disengage each of the main components, including computer signals to control fuel supply to the prime mover so as to maintain computed drive speed according to desired load output and/or generator output when the generator is connected.

2. A system for managing the supply of energy to a customer according to claim 1, where the customer is located in an area serviced by a real-time pool-type energy market and employs a specific commercial arrangement for supply of energy to the customer that provides for the supplier to buy back at applicable pool prices any unused energy based on a schedule of quantity/price by time interval contained in the contract, including any electricity exported to the mains from electricity generated at the premises, with further provision giving the supplier an option to add a price premium to enhance incentive for demand-side response to high pool prices,
said system further comprising a computer system to control energy conversion at the customer premises that monitors the parameters of pool prices, energy supply contract conditions, current load requirements, and expected load changes, taking these parameters into account to determine an optimum mix of energy sources to be used to satisfy load and further taking into account opportunities to profit from export of power into the grid at times when pool prices are high compared to operating/fuel costs as well as the optimum use of intermediate energy storage facilities and supplementary energy sources that may be available, said computer system implementing its decisions according to set procedures including synchronizing generator output prior to connecting to mains supply and providing visual indication/audible alerts of operating conditions on reaching set parameters.

3. A system for managing the supply of energy to a customer according to claim 1, where speed control of the motor-generator when used as a motor and control of electricity output from the motor-generator when used as a generator are managed by use of an inverter/converter unit.

4. A system for managing the supply of energy to a customer according to claim 1, where the power transmission arrangement uses a belt-drive system with pulleys on main drive shafts of each of the main components, the pulleys being associated with a remotely controllable clutch arrangement for engaging or disengaging power transmission to or from the respective main component that is able to be controlled by a signal from the computer.

5. A system for managing the supply of energy to a customer according to claim 1, where the power transmission arrangement uses a fluid-drive system with fluid power converters on the main drive shafts of each of the main components, the fluid power converters having a remotely controllable fluid flow control arrangement for engaging or disengaging power transmission to or from the respective main component that is able to be controlled by a signal from the computer.

6. A system for managing the supply of energy to a customer according to claim 1, where the power transmission arrangement comprises a gear box with three drive shafts respectively coupled to each of the main components, the gear box having facilities to enable each drive shaft to be engaged or disengaged according to a signal from the computer and the gear box also having facilities to independently vary the gear ratios between any two drive shafts on a continuous basis according to signals from the computer.

7. A system for managing the supply of energy to a customer according to claim 1, where the prime mover has two output drive shafts respectively coupled to the load and to the motor-generator by use of constant-velocity flexible couplings with a remotely controllable clutch arrangement associated with each coupling so as to enable engagement or disengagement of the load or the motor-generator following a signal from the computer, and where the prime mover has computer-controllable decompression valves so that when the load is being driven by the motor the prime mover decompression values can be opened to allow the prime mover to idle while allowing power to be transmitted from the motor to the load.

8. A system for managing the supply of energy to a customer according to claim 4, where at least one remotely variable drive-speed-changing device is respectively interposed between the main drive shaft power-transmission coupling of one or more of the main components and the power transmission system, with the remotely variable drive-speed-changing device or devices being controllable by signals from the computer.

9. A system for managing the supply of energy to a customer according to claim 1, where the driven load is a heat pump servicing heating and cooling requirements at the customer's premises, the heat pump being capable of reverse operation so as to alternatively provide heating and cooling with facilities to store heat and coldness to enable periodic operation of the load, the operation of the heat pump being controlled by the computer.

10. A system for managing the supply of energy to a customer according to claim 9, where the heat storage medium is water used at the premises and is contained in two storage tanks connected so as to maintain a temperature gradient therebetween, with one tank being maintained at a high temperature as needed for direct use at the premises and the other tank being used as a medium-temperature storage tank for absorbing heat generated by the prime mover and also acting as a heat source for extracting heat energy to be delivered to the higher-temperature storage tank, with temperature control over the respective tanks and operation of the heat pump being controlled by the computer.

11. A system for managing the supply of energy to a customer according to claim 10, where efficiency of the system is further improved by connecting output warm water from one or more solar hot water panels to the medium-temperature water storage tank, with connection, disconnection, and flow control of water from the solar hot water panels being controlled by the computer;

12. A system for managing the supply of energy to a customer according to claim 9, where the cooling load at the premises is substantially more than the required heating load at least during certain periods and the heat storage medium is water used at the premises and contained in two storage tanks, with one tank being maintained at a high temperature as needed for direct use at the premises and the other tank being used as a low-temperature water storage tank;
the high-temperature storage tank containing heat exchangers to absorb heat generated by the prime mover and heat required to maintain computed temperature levels supplemented by operating the heat pump to transfer heat from the low-temperature storage tank to the high-temperature storage tank; and
the low-temperature storage tank also functioning as a heat pump dump for rejecting heat energy extracted when the heat pump is running in the refrigeration cycle;
all flow of water through the solar hot water panels and heat pump operation being controlled by the computer and the heat pump is operable at higher speed to extend the operating temperature range.

13. A system for managing the supply of energy to a customer according to claim 12, where the reversible heat pump has additional switching facilities to provide an alternate cooling circuit for servicing high refrigeration loads such that the load requirements can be satisfied by running the heat pump at higher speeds than when the alternate cooling circuit is not being used.

14. A system for managing the supply of energy to a customer according to claim 12, where the efficiency of the system is further improved by connecting output hot water from one or more solar hot water panels to the high-temperature water storage tank with the flow of water through the solar hot water panels being restricted so as to deliver water at a higher temperature and by connecting output cold water from same solar hot water panels, operated under forced circulation in the night time, to the low-temperature water storage tank.

15. A system for managing the supply of energy to a customer according to claim 1, where the driven load comprises at least one pump or compressor used in an application where the fluid being pumped can be stored in an intermediate storage container for draw-down by one or more end customers so that it is only necessary to intermittently drive the load connected to the power transmission system (opportunity load);
the computer control of the load and generator operation is able to optimize financial benefit while ensuring that service levels are maintained by varying the quantum of intermediate storage according to load and energy price forecasts by deriving optimum times for operating the opportunity load via the motor and/or via the prime mover, and optimum times for operating the generator, and selectively operating the other load units when available.

16. A system for managing the supply of energy to a customer according to claim 5, further comprising associated facilities for the fluid flow to and from the fluid power converters to be continuously varied by the computer so as to control the speed of the drive shaft of any one or more of the main components.
